(19) United States
(12) Patent Application Publication
(10) Pub. No.: US 2026/0284981 A1
(43) Pub. Date: Sep. 24, 2026

(54) WELDING APPARATUS AND METHOD FOR OPERATING SAME

(71) Applicant: HAVER & BOECKER OHG, Oelde (DE)

(72) Inventors: Volker SCHÜTTE, Oelde (DE); Torsten EVERWAND, Wadersloh (DE)

(21) Appl. No.: 19/474,931

(22) PCT Filed: Apr. 17, 2024
(86) PCT No.: PCT/EP2024/060380

§ 371 Date: Oct. 13, 2025

(30) Foreign Application Priority Data
Apr. 21, 2023 (DE) 10 2023 110 221.4

(51) Int. Cl. B29C 65/00; B29C 39/02; B29C 65/18; B29K 83/00; B29L 31/00; B29L 31/18

(52) U.S. Cl. CPC B29C 66/0342; B29C 39/02; B29C 65/18; B29C 66/81811; B29K 2083/00; B29L 2031/18; B29L 2031/7128

(57) ABSTRACT

A welding apparatus including a main body having a carrier device and a welding element. The carrier device includes a flow channel having an outlet opening in the direction of the welding element. Provided between the welding element and the carrier device is an insulating device which is made of a thermally insulating material. The insulating device includes a fluid passage that is operatively connected to the outlet opening of the flow channel. The method for operating such a welding apparatus includes the welding element being heated to produce a weld seam, and at least after the welding process, at least one fluid is fed to the fluid passage of the insulating device via the outlet opening of the carrier device and is guided via the opening of the fluid passage to the welding element to cool the welding element at least in some portions.

### DESCRIPTION

The present invention relates to a welding apparatus comprising at least one main body with at least one carrier device and at least one welding element. In the installed state, the welding element can be heated and is accommodated on the carrier device. The carrier device comprises at least one flow channel, wherein the flow channel has at least one fluid connection and at least one outlet opening in the direction of the welding element. The present invention also relates to a method of operating such a welding apparatus and a method of producing same.

Welding apparatuses or welding stations have become known in many designs in many areas.

For example, in the production of bags, for example from film, welding stations can be used, among other things, to produce a longitudinal seam to form a tubular film from a partially overlapping layer of film and/or also to introduce bottom seams or top seams. The joining of bag components can also be achieved through a welding station.

In this process, a so-called welding band is usually energised and heated to a relatively high temperature. This results in localised melting of the film, as a result of which it is welded to another layer of film, for example.

After the welding process, the weld seam produced must first cool down for a certain period of time to ensure that it is stable and that the welding band can be easily detached from the film.

This waiting time can considerably reduce the performance of the welding station and thus of the entire system in which the welding station is integrated, since relatively long waiting times are necessary in some cases.

DE 10 2007 057 177 A1 discloses an elongated welding apparatus, wherein a cooling apparatus made of a thermally insulating material is provided between a heating element and a welding bar. A cooling medium is fed to a cooling channel in the cooling apparatus in order to cool the heating element at an accelerated rate. In order to wet the heating element with the cooling medium over as large an area as possible, the heating element is bent and only rests on the edges of the cooling apparatus. The disadvantage here, however, is that the disclosed configuration creates a temperature gradient along the heating element, resulting in uneven cooling. This means that the cooling time has to be significantly extended in some cases in order to ensure sufficient cooling everywhere. In addition, the heating element is not supported by the cooling apparatus since it only rests on the edges. As a result, this configuration is quite unstable and, moreover, the cooling medium can easily escape sideways in an uncontrolled manner.

It is therefore the object of the present invention to provide a welding apparatus with which a fast welding process with a stable weld seam can be reliably achieved.

This object is achieved by a welding apparatus with the features of claim 1, by a method for operating same with the features of claim 19 and by a method for producing same with the features of claim 24. Preferred refinements of the invention are the subject matter of the subclaims. Further advantages and features of the present inventions are apparent from the general description and the description of the exemplary embodiment.

The welding apparatus according to the invention comprises at least one main body with at least one carrier device and furthermore at least one welding element. The welding element is heated or heatable in the installed state and is accommodated at least in some portions on the carrier device. The carrier device comprises at least one flow channel with at least one fluid connection. Furthermore, the flow channel has at least one outlet opening and, in particular, at least two outlet openings in the direction of the welding element. In addition, provided between the welding element and the carrier device is at least one insulating device which is made at least in some portions and, in particular, completely from a thermally insulating material which, in particular, is also thermally resistant and preferably also acts in an electrically insulating manner. In this case, the insulating device comprises at least two fluid passages, each with at least one opening directed towards the welding element, wherein the fluid passage of the insulating device is operatively connected to the outlet opening of the flow channel.

The welding apparatus according to the invention can be used in many technical fields. In particular, such a welding apparatus can be used in the production of bags, in particular film bags, and preferably in an FFS machine (FFS=form fill seal).

The main body of the welding apparatus is, in particular, the component that comprises the carrier device for the welding element. At least one counterpart can be assigned to such a main body, which can also be designed without a welding element. Depending on the configuration, the counterpart can also comprise, for example, a continuously heated preheating plate or the like, and/or alternatively provide a pure contact surface. Depending on the configuration, two or more main bodies with a carrier device and welding element can also be provided so that the welding process can be carried out from both sides.

The insulating device is designed in particular in such a manner that the welding element is substantially and preferably completely thermally decoupled from the carrier device by means of the insulating device.

A welding element is, in particular, at least one welding band, one pulse welding jaw and/or another element which is suitable for producing a weld or a weld seam.

Depending on the configuration, connections for the welding element are provided in the carrier device or fed through the carrier device, so that the welding element can be operated thermally, electrically and/or in another suitable manner.

The fluid connection of the flow channel can in particular be supplied with at least one fluid, wherein a controllable supply is particularly preferred.

The outlet opening of the flow channel in the carrier device can be, for example, a bore or the like which guides the fluid selectively towards the insulating device or the welding element. Depending on the configuration, however, the opening can also be designed, e.g., in a groove-like or slot-like manner so that the flow channel is formed to be open at least in some portions in the direction of the insulating device and is covered by the insulating device or closed except for the openings in the insulating device.

The welding apparatus according to the invention offers many advantages. A significant advantage is that the welding element is accommodated on and thermally decoupled from the carrier device by the insulating device. Furthermore, the special configuration of the insulating device and the carrier device allows the heated welding element to be cooled down relatively quickly before, after and/or during a welding process by means of a fluid, for example an air flow. In particular, a previously created weld seam can also be cooled so that it very quickly achieves sufficient and, depending on the configuration, final stability. This can significantly reduce the process time in some cases.

By passing a fluid used for cooling through the insulating device which is thermally resistant and insulating, particularly rapid cooling of the welding element can be achieved since the contact surface or the receptacle on the carrier device is not heated, or not significantly heated, by the welding element itself.

Preferably, the insulating device consists at least in some portions of silicone. In particular, it is provided that the insulating device consists entirely of silicone or is made therefrom. In particular, silicone the preferred properties of an insulating device because it is both insulating and temperature-resistant.

Particularly preferably, the insulating device comprises at least one cooling channel which operatively connected with the at least one fluid passage. Due to such a configuration, an even better cooling of the welding element is made possible. Depending on the configuration of the cooling channel, the surface area of the welding element being operatively connected to a cool fluid flow can be increased. In useful configurations, the cooling channel has at least one intersection which, in particular, does not pass through the opening of the fluid passage. In this manner, an advantageous fluid distribution within the insulating device can be achieved. The branching offshoots of the cooling channel can branch off transversely or in another manner from the main channel or the cooling channel, e.g., also in a herringbone pattern or in a zigzag pattern.

In preferred configurations, the cooling channel is designed to be open at least in the direction of the welding element, at least in some portions. In particular, with such a configuration, particularly good cooling of the welding element can be achieved since, depending on the configuration of the cooling channel, particularly large-area cooling of the welding element can be achieved, even if a fluid, e.g. an air flow, is only introduced selectively into the insulating device at one or more places.

It is particularly preferred to provide a multiplicity of openings directed towards the welding element, wherein the multiplicity of openings is provided in particular corresponding to the outlet openings of the carrier device. Depending on the configuration, a fluid passage with multiple openings or separate fluid passages each having one opening can be provided in a useful manner.

Preferably, the number of openings in the insulating device corresponds to the number of outlet openings in the carrier device. In this manner, a fluid flow or a fluid can be guided through the opening in the insulating device in the direction of the welding element, preferably through each outlet opening in the carrier device, in order to achieve rapid cooling of the welding element.

Preferably, at least two openings of the insulating device are connected to each other via at least one common cooling channel. This also allows particularly advantageous cooling to be achieved.

In useful refinements, the cooling channel has at least one outlet opening, which is arranged or provided in particular substantially transverse to the opening in the insulating device. With such a configuration it can be achieved in particular that fluid or air can be discharged from the cooling channel, in particular when a welding element would otherwise cover the cooling channel.

The insulating device is preferably designed in a frame-like manner. In such a configuration it is accordingly advantageous to also provide a circumferential flow channel in the carrier device and, in particular, the welding element is also provided in a ring-or frame-like manner and arranged on the carrier device or on the insulating device.

Depending on the configuration, however, the insulating device can also be designed in a bar-like or elongated manner. In general, the desired configuration of the weld seam is decisive for the shape and configuration of the welding element and/or the insulating device.

In general, the welding element or the carrier device or the insulating device or the components associated with these components can also be shaped in such a manner that three-dimensional shapes can be created, or the weld seam follows a three-dimensional contour.

In advantageous refinements, at least one processing device is provided which is suitable and designed to be accommodated at least in some portions in the carrier device and to engage at least temporarily and at least in some portions through the plane of the welding element. Such a configuration makes it possible to provide further work steps simultaneously with and/or also with a time delay to a welding, and/or also to arrange auxiliary means in the welding apparatus or in the main body and/or the counterpart. For example, a blade and/or a gripper device, such as a vacuum gripper, can be provided.

Preferably, at least one covering device is provided, which in particular covers the welding element. Depending on the configuration, the covering element also covers the insulating device, and/or the carrier device, or the main body at least in some portions. In particular, a covering device is designed to be thermally conductive and/or is provided with the welding element.

In advantageous configurations, the covering device comprises at least one recess for the processing device to pass through. In such a configuration, the welding element is securely covered in a useful manner while still allowing the use of any processing device provided.

Preferably, at least one quick-change device is provided, in particular with an angle compensating device. By means of such a quick-change device, the welding apparatus or welding element can be attached and aligned particularly quickly.

Preferably, the flow channel in the carrier device is provided to cool the carrier device at least in some portions. This makes it possible, in particular, to cool the heating that is transferred to the carrier device despite the insulating device at the same time as cooling the welding element.

In particular, it is provided that the flow channel comprises at least one exhaust air channel, which can in particular comprise at least one sound absorber or the like. An exhaust air channel can be used, for example, to ensure that an excess of a fluid used for cooling can be fed to the insulating device. The excess fluid then escapes via the exhaust air channel. Depending on the design, the exhaust air volume can be regulated by means of the sound absorber and unwanted noises of the escaping fluid can be reduced or even avoided.

In useful refinements, the insulating device is suitable and designed to effect the fluid flow to be directed to the side of the welding element. With such a configuration, particularly suitable cooling of the welding element can be achieved. This can be achieved in particular by a corresponding shape and/or correspondingly provided cooling channels and/or openings.

The insulating device is preferably suitable and designed to cool at least one electrical connection of the welding element. In particular, openings and/or cooling channels can be provided in the insulating device in such a manner that a fluid guided through the insulating device also cools the electrical connections of the welding element.

Particularly preferably, the insulating device is suitable and designed to direct a fluid flow at least in some portions directly onto the welding element. For this purpose, the welding element is provided in particular directly downstream of the opening in the insulating device in the direction of flow. In this manner, a fluid passed through the opening is directed directly onto the welding element. Preferably, no barriers or the like are provided between the opening in the insulating device and the welding element.

The method according to the invention is suitable for operating a welding apparatus as described above. In this case, the welding element is heated to produce a weld seam, wherein, at least after the welding process, at least one fluid is fed to the fluid passage of the insulating device via the outlet opening in the carrier device and is guides to the welding element via the opening of the fluid passage in the insulating device in order to cool the welding element at least in some portions.

In particular, cooling the welding element at least in some portions and at least temporarily also effects cooling of the previously produced weld seam.

The method according to the invention also offers the advantages already described above. In particular, a significantly faster cooling of the welding element can be achieved which also allows in particular to effect simultaneous cooling and thus preferably stabilisation of the weld seam.

Preferably, the supplied fluid is temperature-controlled. In particular, a cooled, or pre-cooled, or cold fluid such as cooled air, and/or a cooled or cold gas, and/or a cooled gas mixture can be supplied as the fluid in order to achieve even faster cooling of the welding element.

Particularly preferably, at least one cooling channel is provided in the insulating device and the insulating device is cooled by at least one fluid guided through the cooling channel. In particular, simultaneous cooling of the insulating device and the welding element can be provided. Depending on the configuration, however, certain structural features can also be provided, for example separate cooling channels, in order to cool only the insulating device, at least in some portions.

Particularly preferably, at least one cooling channel is provided in the insulating device and the welding element is cooled at least in some portions by at least one fluid fed through the cooling channel. By providing at least one cooling channel through which the fluid introduced into the insulating device via the opening is further distributed, a welding element can be cooled particularly well and, in particular, over a larger area.

In useful configurations, at least one processing device engages at least in some portions through the plane of the welding element before, after and/or during the welding process. Such a configuration can be provided in particular if a frame-like welding apparatus or a frame-like welding element with correspondingly frame-like further components is provided.

Another method according to the invention is suitable for producing at least one insulating device for at least one welding apparatus as described above. At least one at least two-part casting mould is provided, wherein liquefied insulating material, for example liquid silicone, is poured into the casting mould.

Preferably, the material is then removed after curing.

In particular, with the method according to the invention for producing an insulating device, a particularly simple production of insulating devices is made possible.

In this manner, the sometimes preferred complex structures with a multiplicity of openings and/or branched cooling channels can be produced in a quick and clean manner by means of the moulding process.

In particular, the casting mould is produced at least in some portions in at least one 3D printing process. This allows for particularly cost-effective, simple and flexible production of casting moulds.

Further advantages and features of the present invention are apparent from the exemplary embodiment which is explained below with reference to the accompanying figures.

In the figures:

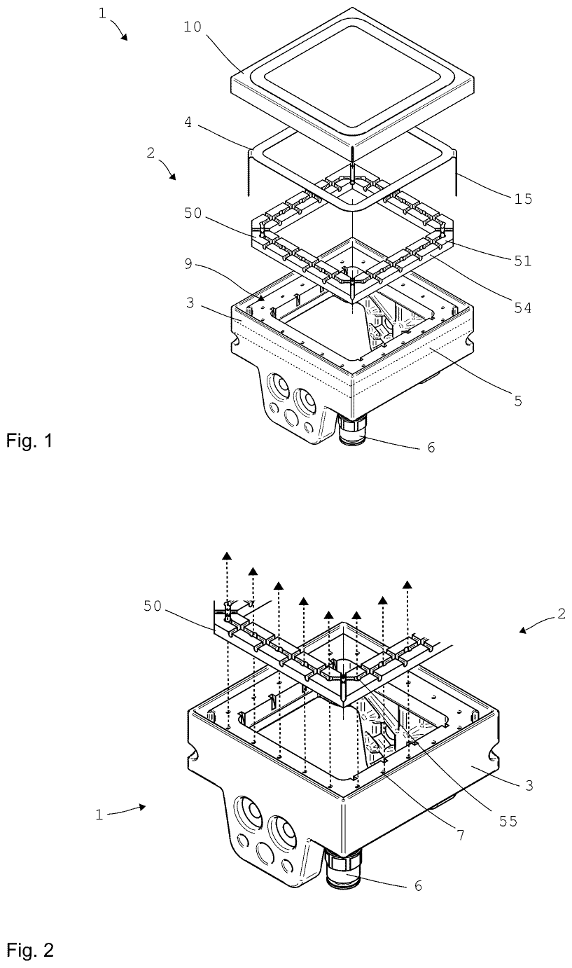

FIG. 1 shows a purely schematic illustration of an exemplary embodiment example of a welding apparatus according to the invention in an exploded view;

FIG. 2 shows a purely schematic detailed illustration of FIG. 1;

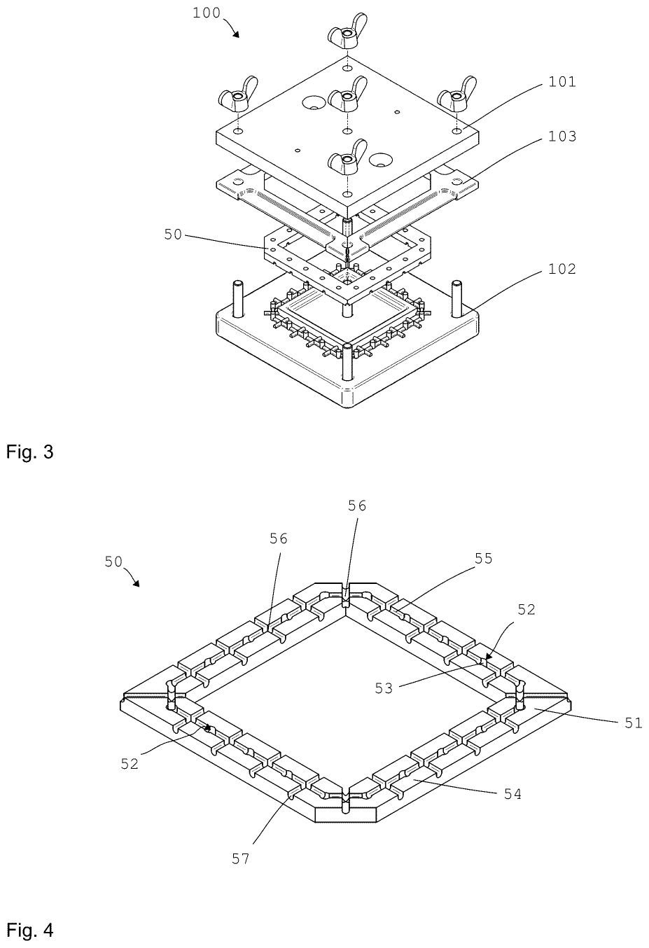

FIG. 3 shows a purely schematic illustration of an exemplary embodiment of a mould for an insulating device for a welding apparatus according to the invention in an exploded view;

FIG. 4 shows a purely schematic illustration of an exemplary embodiment of an insulation device for a welding apparatus according to the invention in a perspective view;

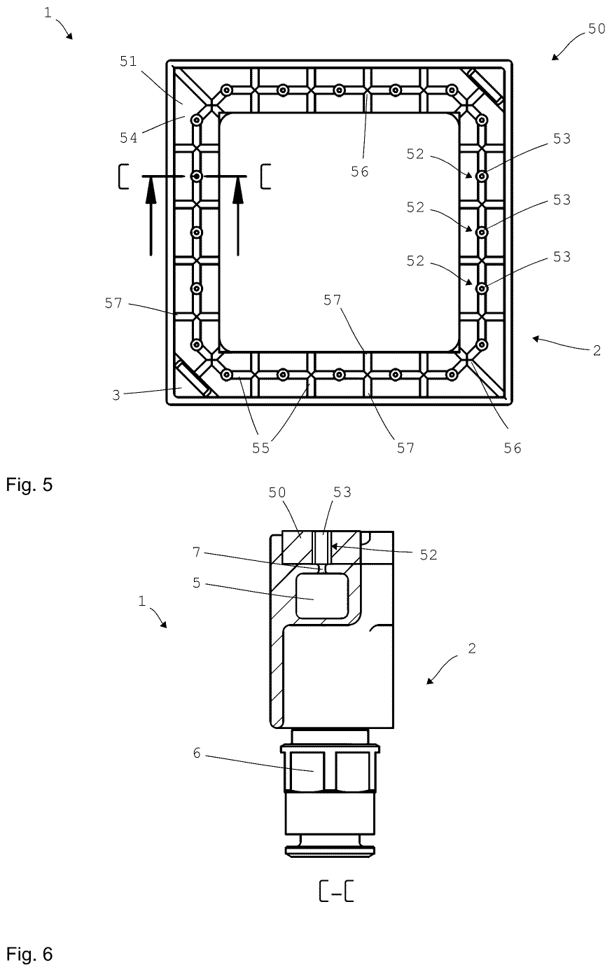

FIG. 5 shows a purely schematic illustration of an exemplary embodiment of a welding apparatus according to the invention in a top view;

FIG. 6 shows a purely schematic illustration of an exemplary embodiment of a welding apparatus according to the invention in a sectional side view;

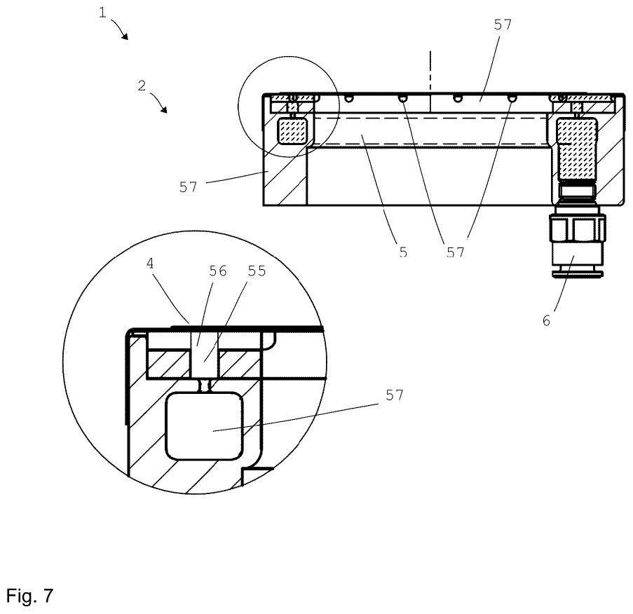

FIG. 7 shows a purely schematic illustration of an exemplary embodiment of a welding apparatus according to the invention in a sectional side view with enlarged detail;

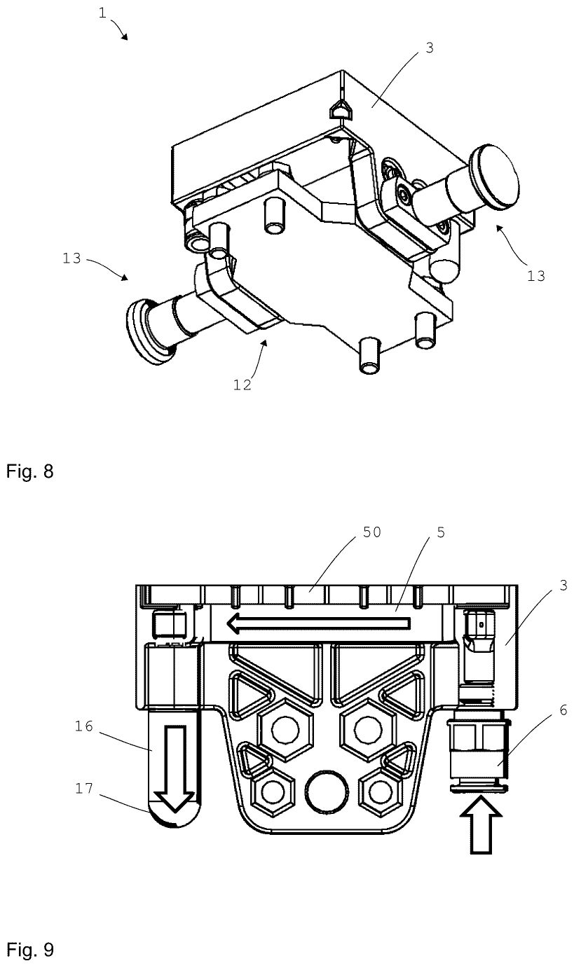

FIG. 8 shows a purely schematic illustration of an exemplary embodiment of a welding apparatus according to the invention in a perspective view;

FIG. 9 shows a purely schematic illustration of an exemplary embodiment of welding apparatus according to the invention in a sectional side view;

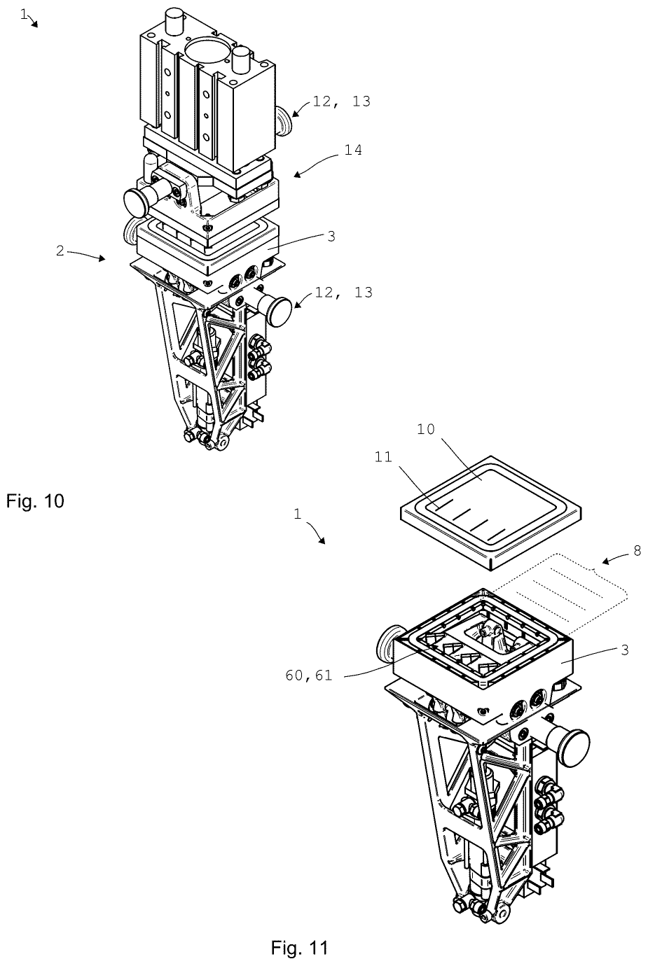

FIG. 10 shows is a purely schematic illustration of an exemplary embodiment of a welding apparatus according to the invention in a perspective view;

FIG. 11 shows a partial perspective view of the exemplary embodiment according to FIG. 10;

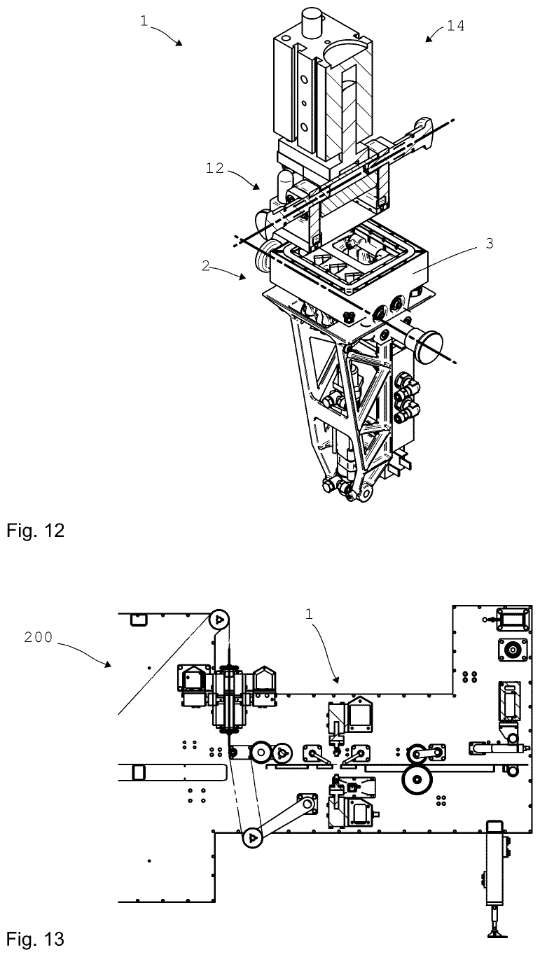

FIG. 12 shows the illustration according to FIG. 10 in a partially sectioned view;

FIG. 13 shows a purely schematic illustration of an exemplary embodiment of a welding apparatus according to the invention in a bag production apparatus in a side view;

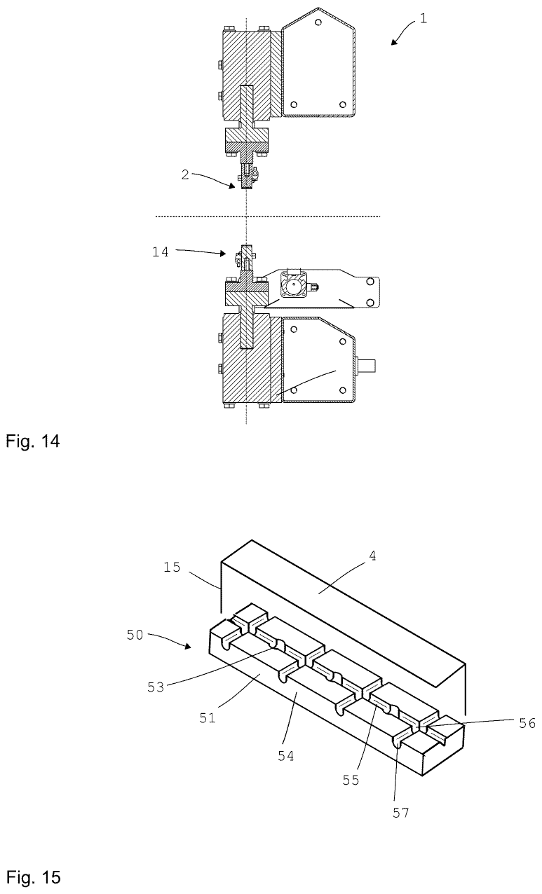

FIG. 14 shows a detailed view of the welding apparatus according to FIG. 13; and

FIG. 15 shows a detailed view of an insulating device for a welding apparatus according to FIG. 13.

FIG. 1 shows a purely schematic exemplary embodiment of a welding apparatus 1 according to the invention in an exploded view.

In the exemplary embodiment shown here, the welding device 1 according to the invention comprises a main body 2, which provides a carrier device 3. In the exemplary embodiment shown, the carrier device 3 has a receptacle 9 for an insulating device 50.

In the installed state, the insulating device 50 is arranged between the carrier device 3 and a welding element 4, which is designed here as a welding band. Here, the welding element 4 can be heated via electrical connections 15.

Furthermore, in the exemplary embodiment shown here, a covering device 10 is provided, which is provided here as a closure of the main body 2 and which covers the welding element 4 here.

In the exemplary embodiment shown, the welding element 4 is provided in a frame-like manner so that a circumferential weld seam can be created. Therefore, the configuration of the insulating device 50 and the carrier device 3 or the main body 2 is also provided accordingly here.

The insulating device 50 is made of a thermally resistant and insulating material 51 so that it is not damaged by the welding element during welding and also does not, or not significantly, absorb and/or transfer the heat generated during welding. In the exemplary embodiment shown, the insulating device 50 is made entirely of silicone 54.

In FIG. 2, the main body 3 and the insulating device 50 are shown again in an enlarged illustration. It can be seen here that in the carrier device 3 or the main body 2, a flow channel 5 is provided into which a fluid such as air, a gas or, depending on the configuration, a liquid and/or the like can be introduced via a fluid connection 6.

In the direction of the welding element 4 or the insulating device 50, multiple outlet openings 7 are provided in connection with the flow channel 5 in the exemplary embodiment shown here, which are provided here corresponding to openings 53 of a fluid passage 52 of the insulating device 50.

The fluid fed into the flow channel 5 via the fluid connection 6 is guided via the outlet opening 7 through the fluid passage 52 or the openings 53 towards the welding element 4. In the exemplary embodiment shown here, the openings 53 are connected to each other via a cooling channel 55, so that a particularly large-area cooling of the welding element 4 can be achieved via the fluid flowing through the openings 53 or the cooling channel 5.

FIG. 3 shows a purely schematic casting mould 100 which can be used to produce an insulating device 50 for a welding apparatus 1 according to the invention.

In the exemplary embodiment shown, the casting mould 100 is provided in multiple parts and comprises an upper part 101 and a lower part 102, wherein an intermediate part 103 is also provided here for shaping.

For producing an insulating device 50 from a thermally insulating material 51, the casting mould 1 is assembled and liquefied material 51 is poured into the casting mould 100 through the filling openings 104.

After hardening, the casting mould 100 can be disassembled and the insulating device 50 can be removed. In the exemplary embodiment shown, the casting mould 100 is produced using a 3D printing process, which in particular also allows for the flexible production of complex insulating devices 50, including those with a three-dimensional configuration or shape.

FIG. 4 is a purely schematic illustration of an insulating device 50 for a welding apparatus 1 according to the invention, which can be used, for example, in the exemplary embodiment shown in FIGS. 1 and 2.

In the exemplary embodiment shown here, the frame-like insulating device 50 is made entirely of a thermally insulating material 51, in this case silicone 54. Silicone 54 also offers the advantage that the material is not only thermally insulating but also thermally resistant.

In the exemplary embodiment shown, it can be seen that the fluid passage 52 of the insulating device 50 comprises a multiplicity of openings 53 through which fluid supplied via the outlet openings 7 flows out. In the exemplary embodiment shown, the openings 55 are connected to each other via a cooling channel so that the fluid used for cooling can flow through the openings 55 and also further through the channel 55, thereby achieving even better cooling of the welding element 4.

In the exemplary embodiment shown here, intersections 56 are provided in the cooling channel 55, which are provided at a different position than the openings 55, or not provided in the region of the openings 55. Outlet openings 57 can be provided via the intersections 56, which provide transverse branches of the cooling channel 52, so that the air flowing through the cooling channel 55 can also escape when the cooling channel 55 is covered at the top by the welding element 4.

The exemplary embodiment shown also illustrates that the cooling channel 55 also extends into the corner areas of the frame device in which the electrical connections 15 of the welding element 4 run, so that these can also be cooled by means of the insulating device 50 or by means of the air or fluid flowing through the cooling channels 55.

FIG. 5 shows a purely schematic exemplary embodiment of a welding apparatus 1 according to the invention in a top view. Here, too, the frame-like configuration of the insulating device 50 can be seen, which in this case consists of a thermally insulating material 51, wherein silicone was also used as the material here.

Here, too, the intersections 56 in the cooling channel 55 can be seen, which allow for good distribution of the fluid used to cool the welding element 4.

In addition, it can be seen in the lower left and upper right corners that a special shape of the insulating device 50 is provided to also allow cooling of the electrical connections 15, which are flap-like here. The insulating device 50 is also provided to be electrically insulating here.

FIG. 6 purely schematically shows a cross-section through area C-C in FIG. 5. Here, the flow channel 5 in the carrier device 3 of the main body 2 can be seen. It is shown that outlet openings 7 extend from the flow channel 5 in the direction of the welding element 4 to be cooled, to each of which corresponding openings 53 of the fluid passage 52 in the insulating device 50 are assigned.

If a fluid is fed into the flow channel 5 via the fluid supply 6, it can enter the fluid passage 52 or the corresponding openings 53 via the outlet openings 7 and thus directly impinge on the welding element 4 located above it, thereby cooling it.

FIG. 7 shows another sectional side view through a welding apparatus 1 according to the invention, with the flow channel 5 also been shown here. A cross-section through the cooling channel 55 of the insulating device 50 in the region of an intersection 56 is shown here. Thus, the open ends of the transversely running channel portions or the outlet openings 57 can also be seen here.

FIG. 8 shows purely schematically a perspective view of an exemplary embodiment of a welding apparatus 1 according to the invention or of a main body 2 of such a welding apparatus 1.

In the exemplary embodiment shown here, it can be seen that the main body 2 or the welding apparatus 1 in general comprises a quick-change device 12, which here also comprises an angle compensating device 13.

FIG. 9 shows purely schematically a sectional view of the fluid flow through the main body 2 or the carrier device 3 of a welding apparatus 1 according to the invention.

In this case, fluid is fed into the flow channel 5 via a fluid connection 6. In the exemplary embodiment shown here, it is illustrated that an exhaust air channel 16 can also be provided at one end of the flow channel. This exhaust air channel 16 discharges excess fluid, which is supplied in excess to the insulating device 50. Furthermore, a sound absorber 17 is connected here, via which the amount of exhaust air can be adjusted, and which reduces or prevents unwanted noise development, for example hissing or whistling. Such a sound absorber 17 can preferably also provide the function of a pressure relief valve.

FIG. 10 shows a purely schematic exemplary embodiment of a welding apparatus 1 according to the invention, wherein the welding apparatus 1 is shown here in an assembled state.

Here, the welding device 4 has a main body 2 and a counterpart 14. In the exemplary embodiment shown, both the main body 2 and the counterpart 14 comprise a quick-change device 12 with an angle compensating device 13. In this case, the receptacles of the main body 2 and counterpart 14 are provided to be offset by 90° or rotated relative to each other so that optimum alignment in all directions or in all planes can be carried out via the angle compensating devices 13 of the main body 2 and counterpart 14.

In the exemplary embodiment shown here, the counterpart 14 does not comprise a welding element 4 but only serves as a support surface or counter surface for welding.

In FIG. 11, the main body 2 of the welding apparatus 1 according to FIG. 10 is illustrated purely schematically, wherein in the exemplary embodiment shown here it is shown by way of example that a processing device 60 can be arranged in the main body 2, wherein the processing device 60 is designed here as a cutting device 61 with a plurality of blades.

Accordingly, in the exemplary embodiment shown, the covering device 10 has recesses 11 through which the cutting device 61 can pass upon actuation. It is thus possible for the cutting devices 61 to pass through the plane 8 of the welding element 4 for processing, for example, a film during bag production.

FIG. 12 purely schematically shows a partially sectioned perspective view of the welding apparatus 1 shown in FIG. 10.

Here, the quick-change device 12 with the angle compensating device 13 can be seen on the counterpart 14.

FIG. 13 shows an exemplary embodiment of a bag production apparatus 200 comprising a welding apparatus 1 according to the invention.

In FIG. 14, the welding device 1 of FIG. 13 is illustrated in a sectional side view. In the exemplary embodiment shown here, the welding device comprises two main bodies 2 each having one welding element 4, which are moved towards each other for welding a film in order to form a bag.

FIG. 15 purely schematically shows by way of example that a welding element 4 and thus also the corresponding insulating device 50 and the carrier device (not shown) can have a bar-like or elongated design.

Such a configuration is shown purely schematically and by way of example as a further embodiment in comparison to the previously frame-like configuration of a welding element 4 or an insulating device 50.

### REFERENCE LIST

1 welding apparatus
2 main body
3 carrier device
4 welding element
5 flow channel
6 fluid connection
7 outlet opening
8 plane
9 receptacle
10 covering device
11 recess
12 quick-change device
13 angle compensating device
14 counterpart
15 electrical connection
16 exhaust air duct
17 sound absorber
50 insulating device
51 insulating material
52 fluid passage
53 opening
54 silicone
55 cooling channel
56 intersection
57 outlet opening
60 processing device
61 cutting device
100 casting mould
101 upper part
102 lower part
103 intermediate part
200 bag production apparatus

1. A welding apparatus, comprising: at least one main body having at least one carrier device and at least one welding element; wherein the welding element is heatable in the installed state and is accommodated on the carrier device; and wherein the carrier device comprises at least one flow channel with at least one fluid connection;
the flow channel has at least one outlet opening in the direction of the welding element; between the welding element and the carrier device at least one insulating device is provided which is made at least in some portions from a thermally insulating material; and the insulating device comprises at least two fluid passages each with at least one opening directed towards the welding element, wherein the fluid passages of the insulating device are operatively connected to the outlet opening of the flow channel.

2. The welding apparatus according to claim 1, wherein the insulating device includes silicone.

3. The welding apparatus according to claim 1, wherein the insulating device comprises at least one cooling channel which is operatively connected to the at least one fluid passage.

4. The welding apparatus according to claim 3, wherein the cooling channel has at least one intersection which does not pass through the opening of the fluid passage.

5. The welding apparatus according to claim 3, wherein the cooling channel is designed to be open in the direction of the welding element.

6. The welding apparatus according to claim 1, wherein a multiplicity of openings directed towards the welding element is provided.

7. The welding apparatus according to claim 6, wherein the number of openings corresponds to the number of outlet openings in the carrier device.

8. The welding apparatus according claim 3, wherein at least two openings are connected to each other via at least one common cooling channel.

9. The welding apparatus according to claim 3, wherein the cooling channel has at least one outlet opening which, in particular, is arranged substantially transverse to the opening.

10. The welding apparatus according to claim 1, wherein the insulating device is designed in a frame-like manner.

11. The welding apparatus according to claim 1, wherein at least one processing device is provided which is suitable and designed to be accommodated at least in some portions in the carrier device and to engage at least temporarily and at least in some portions through the plane of the welding element.

12. The welding apparatus according to claim 1, wherein at least one covering device is provided.

13. The welding apparatus according to claim 12, wherein the covering device comprises at least one recess for passing through the processing device.

14. The welding apparatus according to claim 1, wherein at least one quick-change device is provided with an angle compensating device.

15. The welding apparatus according to claim 1, wherein the flow channel is provided in the carrier device for cooling the carrier device.

16. The welding apparatus according to claim 1, wherein the insulating device effects the fluid flow to be directed to the side of the welding element.

17. The welding apparatus according to claim 1, wherein the insulating device is suitable and designed to cool at least one electrical connection of the welding element.

18. The welding apparatus according to claim 1, wherein the insulating device is suitable and designed to direct a fluid flow at least in some portions directly onto the welding element.

19. A method for operating a welding apparatus according to claim 1, wherein
that the welding element is heated to produce a weld seam and at least after the welding process, at least one fluid is fed to the fluid passage of the insulating device via the outlet opening of the carrier device and is guided via the opening of the fluid passage to the welding element in order to cool the welding element at least in some portions.

20. The method according to claim 19, wherein the fed fluid is temperature-controlled.

21. The method according to claim 19, wherein the insulating device is cooled by at least one fluid guided through the cooling channel.

22. The method according to claim 19, wherein the welding element is cooled by at least one fluid guided through the cooling channel.

23. The method according to claim 19, wherein at least one processing device engages at least in some portions through the plane of the welding element before, after and/or during the welding process.

24. A method for producing at least one insulating device for a welding apparatus according to claim 1,
wherein at least one at least two-part casting mould is provided and liquid material is poured into the casting mould.

25. The method according to claim 24, wherein the casting mould is produced at least in some portions in at least one 3D printing process.
